(19) United States
(12) Patent Application Publication
(10) Pub. No.: US 2016/0075224 A1
(43) Pub. Date: Mar. 17, 2016

(54) MODULAR HYBRID SYSTEM

(71) Applicant: MAGNA CLOSURES INC., NEWMARKET (CA)

(72) Inventors: TRAIAN MIU, OAKVILLE (CA); J.R. SCOTT MITCHELL, NEWMARKET (CA); GABRIELE WAYNE SABATINI, KESWICK (CA); MARLON D.R. HILLA, NEWMARKET (CA); SAMUEL R. BARUCO, AURORA (CA)

(21) Appl. No.: 14/853,097

(22) Filed: Sep. 14, 2015

Related U.S. Application Data
(60) Provisional application No. 62/051,578, filed on Sep. 17, 2014.

(51) Int. Cl. B60K 6/48; H02K 7/14; H02K 9/19; H02P 23/00

(52) U.S. Cl. CPC B60K 6/48; H02P 23/0036; H02K 7/14; H02K 9/19; Y10S 903/903

(57) ABSTRACT

An electric propulsion system for use with a vehicle including a pair of first wheels, a pair of second wheels, and a gas propulsion system. The electric propulsion system includes a first electric traction motor mounted to one of the first wheels, and a second electric traction motor mounted to the other one of the first wheels. The electric propulsion system includes pair of electric motor controllers each in electrical communication with a respective one of the first or second electric traction motors. Each of the electric motor controllers are also in electrical communication with the system controller and configured to receive vehicle signals from the system controller to control the respective electric traction motors accordingly. Put another way, the pair of electric motor controllers react to vehicle conditions to provide vehicle assist power to the gas propulsion system as needed.

### CROSS REFERENCE TO RELATED APPLICATION

This U.S. patent application claims the benefit of U.S. provisional patent application No. 62/051,578, filed Sep. 17, 2014, the entire content of which is incorporated herein by reference.

### BACKGROUND

1. Field

The present disclosure relates generally to vehicles that are powered at least partly by an electric propulsion or drive system including at least one electric traction motor and at least one electric motor controller.

2. Related Art

This section provides background information related to the present disclosure which is not necessarily prior art.

The automobile industry is actively working to develop alternative powertrains in an effort to significantly reduce or eliminate the emissions exhausted into the air by conventional powertrains equipped with an internal combustion engine. Significant development has been directed toward electric vehicles (EV) that are equipped with one or more electric traction motors. For example, some electric vehicles are only powered by the electric motor(s) and rely solely on the electrical energy stored in an on-board battery pack. However, some other electric vehicles, commonly referred to as hybrid electric vehicles (HEV), have both an internal combustion engine and one or more traction motors.

There are two types of hybrid electric vehicles, namely, series hybrid and parallel hybrid. In series hybrid electric vehicles, tractive power is generated and delivered to the wheels by the electric traction motor(s) while the internal combustion engine is used to drive a generator for charging the battery pack. In parallel hybrid electric vehicles, the traction motor(s) and the internal combustion engine work independently or in combination to generate and deliver tractive power to the wheels.

Various types of electric and hybrid powertrain arrangements are currently being developed. For example, some electric vehicles are equipped with wheel-mounted electric traction motor/gearbox assemblies. In such an arrangement, a fixed-ratio gear reduction is provided between the traction motor and the driven wheel hub. In other arrangements, an electric propulsion system is used to generate and deliver tractive power to a pair of wheels. The electric propulsion system may include an electric traction motor, a final drive assembly including a differential unit that is adapted for connection to the wheels, and a reduction gearset directly coupling an output component of the traction motor to an input component of the differential unit. The reduction gearset may be based on a layshaft configuration or a planetary configuration for the purpose of providing a desired speed reduction and torque multiplication between the traction motor and the differential unit. Thus, the electric propulsion system is essentially a single-speed or “direct drive” transaxle that can be adapted to drive either the front wheels or the rear wheels of the vehicle.

In some other electric or hybrid vehicles, the electric propulsion system can include a pair of electric traction motors each mounted in-board of the wheel and having a gear reduction unit coupled to drive an axleshaft for transmitting tractive power to the wheel. These traction motors can be independently controlled to distribute balanced power and traction to each wheel without concern for inter-wheel slip associated with conventional vehicles equipped with a differential unit. In a vehicle equipped with such a “dual motor” electric propulsion system, this balancing of power and traction can provide side-to-side (i.e., “left-to-right”) control in either of a front wheel drive (FWD) or rear wheel drive (RWD) vehicular configuration. Alternatively, electric propulsion systems can be used at both the front and rear of the vehicle to provide four independently controllable traction motors and generate balanced power and traction for both left-to-right and front-to-rear control to establish a four-wheel drive (4WD) vehicular configuration. Such dual motor electric propulsion systems typically include fixed-ratio gearsets between the traction motor and the axleshaft. Fixed-ratio gearsets may, however, require a compromise between low end torque and top end speed as well as the need to utilize larger motors to accommodate all torque and speed requirements.

In view of the above, it would be beneficial to provide technology that addresses and overcomes these issues so as to facilitate the design and manufacture of electric drive vehicles having optimized power and traction delivery characteristics.

### SUMMARY

This section provides a general summary of the disclosure, and is not a comprehensive disclosure of its full scope or all of its features.

According to an aspect of the present disclosure, an electric propulsion system for a vehicle is disclosed. The vehicle may include a pair of first wheels, a pair of second wheels, and a system controller. The electric propulsion system may be configured to provide electric tractive power to either of the first wheels or the second wheels and can include a first electric traction motor operatively connected to one of the first or second wheels, a second electric traction motor operatively connected to the other one of the first or second wheels, and at least one electric motor controller interconnected or in electrical communication with the first and second electric traction motors.

In accordance with one embodiment of the electric propulsion system, the first electric traction motor is mounted to and adapted to drive one of the first wheels and the second electric traction motor is mounted to and adapted to drive the other one of the first wheels to establish a rear wheel drive (RWD) electric vehicle. Put another way, the first electric traction motor is built into one of the first wheels and the second electric traction motor is built into the other one of the first wheels. In accordance with another embodiment of the electric propulsion system, the first electric traction motor is mounted to and adapted to drive one of the second wheels and the second traction electric motor is mounted to and adapted to drive the other one of the second wheels to establish a front wheel drive (FWD) electric vehicle. In either embodiment, the electric propulsion system does not require a gearbox to electrically drive the first or second pair of wheels. As a result, the preferred embodiments reduce complexity, parts, and overall cost for the electric propulsion system.

In accordance with these and other aspects, features and advantages, the electric propulsion system of the present disclosure may also include a pair of electric motor controllers each in communication with a respective electric traction motor as well the system controller. Each of the electric motor controllers communicates and receives vehicles signals from the system controller and controls the respective electric traction motors accordingly. Put another way, the pair of electric motor controllers react to the vehicle conditions of the combustion engine received from the system controller to provide vehicle assist power as needed. Since the electric propulsion system is designed to only listen to the gas propulsion system, i.e., does not output signals to the gas propulsion system, the electric propulsion system can be universally applied to all vehicles for establishing a modular approach of implementing the electric propulsion system. Put another way, the electric propulsion system assists the vehicle without interfering with or compromising existing engine control.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Other advantages of the present disclosure will be readily appreciated, as the same becomes better understood by reference to the following detailed description when considered in connection with the accompanying drawings wherein:

FIG. 1 is a perspective view of a vehicle including a gas propulsion system;

FIG. 2 is a perspective view of a vehicle including a gas propulsion system and an electric propulsion system;

FIG. 3 illustrates the electric propulsion system of FIG. 2 in greater detail;

FIG. 4 is a top view of a portion of the electric propulsion system;

FIG. 5 is a perspective view of an exemplary electric traction motor of the electric propulsion system;

FIG. 6 is a side view of the electric traction motor of FIG. 4; and

FIG. 7 s a perspective view of an exemplary arrangement of a battery pack of the electric propulsion system.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

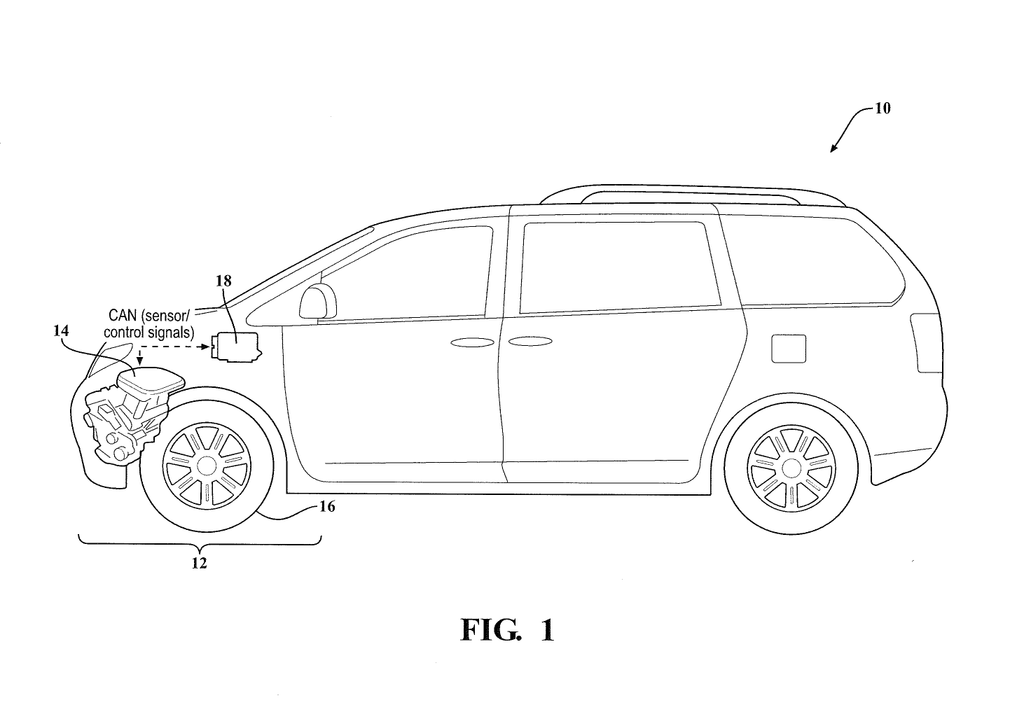

Referring initially to FIG. 1, an exemplary arrangement of a prior art gas propulsion system 12 for a vehicle 10 includes an engine 14 operative coupled to drive a pair of first ground engaging wheels 16. An engine module 18 is in electrical communication with the engine 14 by way of the vehicle bus (CAN) to receive and send signals to the engine 14.

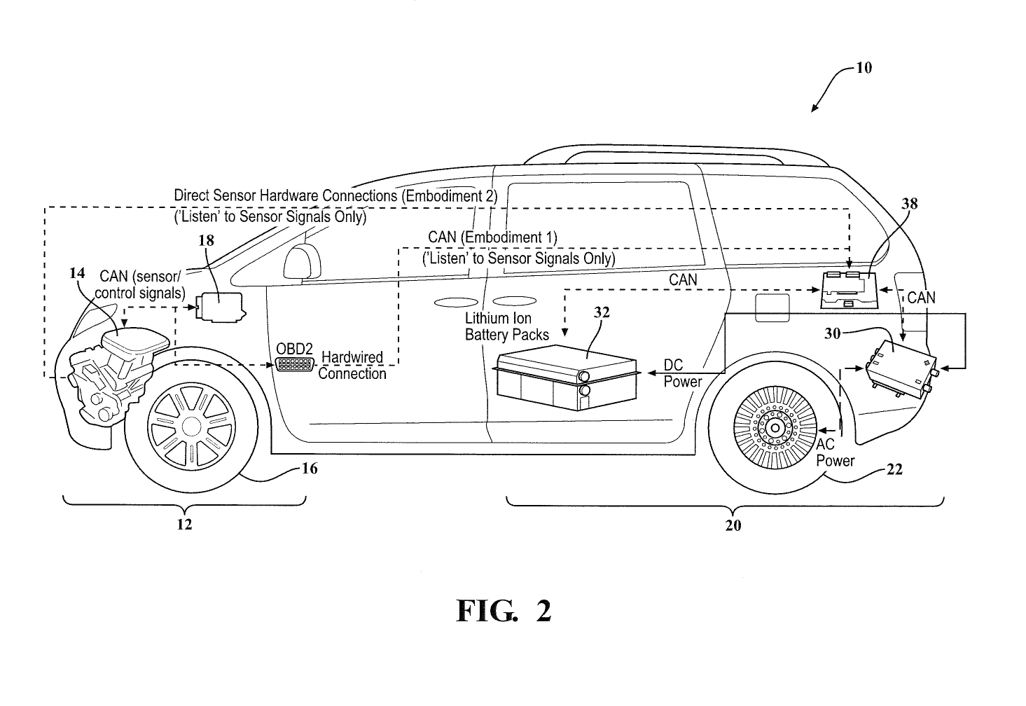

With reference to FIG. 2, an exemplary arrangement of a modular hybrid system for a vehicle 10 in accordance with the subject disclosure includes the gas propulsion system 12 described immediately above as well as an electric propulsion system 20 for driving a pair of second ground engaging wheels 22. Although the electric propulsion system 20 is illustrated and arranged as the rear driveline of the vehicle 10, the electric propulsion system 20 can also be arranged as the front driveline of the electric vehicle without departing from the scope of the subject disclosure.

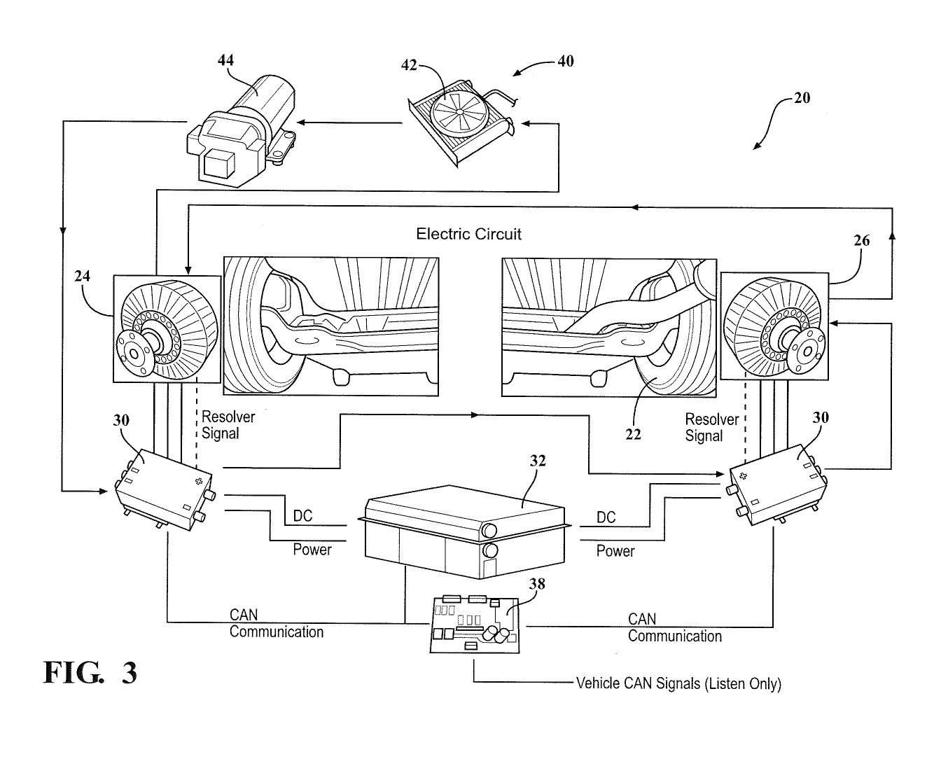

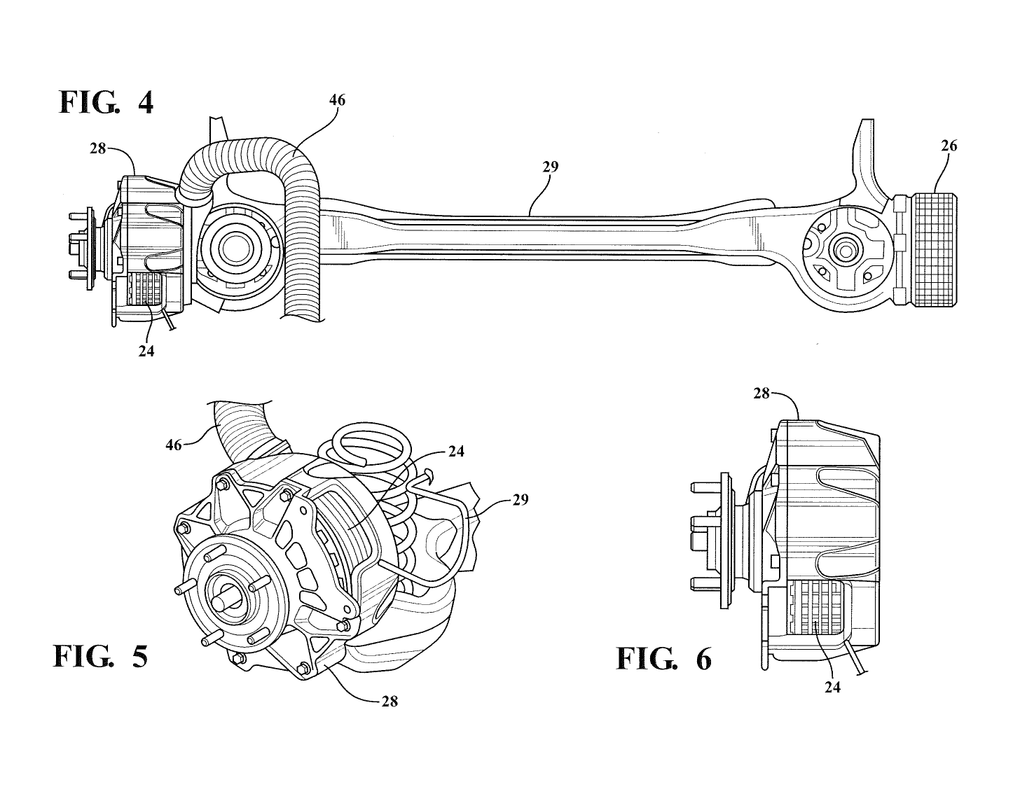

As best shown in FIG. 3, in an exemplary embodiment the electric propulsion system 20 includes a first electric traction motor 24 mounted to one of the second wheels 22 and a second electric traction motor 26 mounted to the other one of the second wheels 22. As best shown in FIGS. 4 and 5, in an exemplary embodiment, the first and second electric traction motors 24, 26 are preferably surrounded or enclosed by a motor housing 28. As further shown in FIG. 4, in an exemplary embodiment, the electric traction motors 24, 26 are mounted to the second wheels 22 by removing end segments of the respective vehicle axle 29 and then welding the motor housing 28 onto the respective truncated axle ends. The modification of the vehicle axle 29 to provide for a mounting of the electric traction motors 24, 26 within or on each of the second wheels 22 results in a direct drive of the second wheels 22 by the electric traction motors 24, 26.

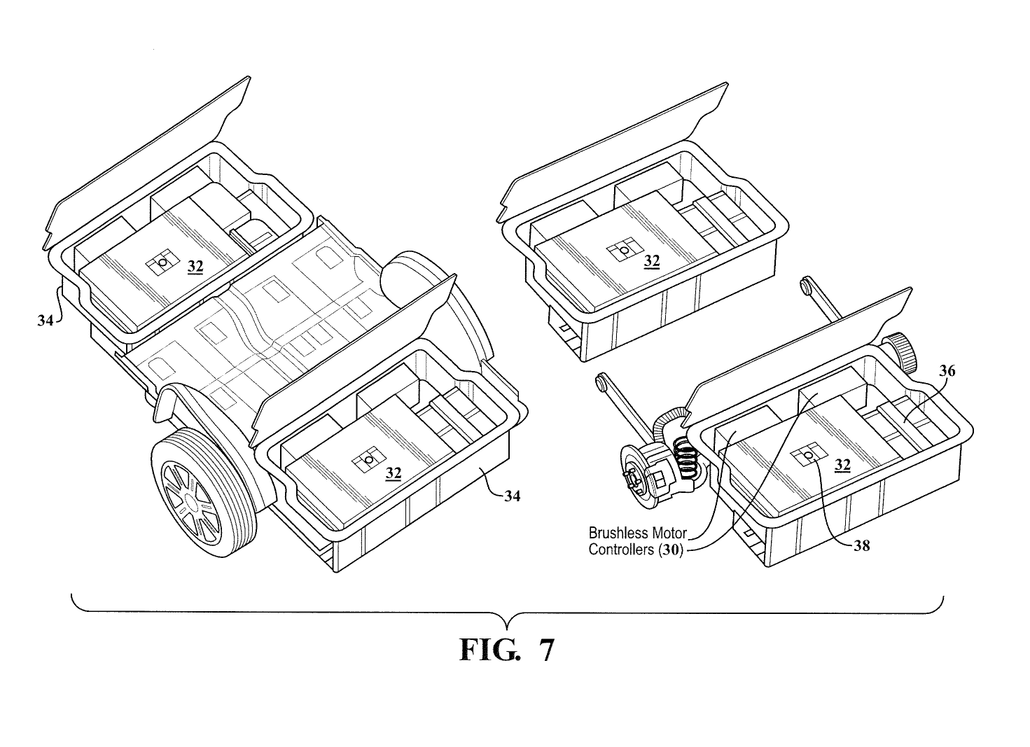

As shown in FIG. 3, the electric propulsion system 20 also includes a pair of electric motor controllers 30 each in communication with a respective one of the first or second electric traction motors 24, 26 and each powered by a battery pack 32. As shown in FIG. 7, in an embodiment, the electric propulsion system 20 can also include a pair of battery packs 32 which are each in communication with a battery box 34 and a battery charger 36.

As shown in FIG. 2, the electric propulsion system 20 also includes an electric propulsion system controller 38 which is in electrical communication with the engine module 18. Each of the pair of electric motor controllers 30 are individually in communication with the system controller 38 and thus capable of receiving vehicle signals from the system controller 38 to control the respective electric traction motors 24, 26 accordingly. Put another way, the pair of electric motor controllers 30 listen and react to the vehicle CAN signals, as received from the system controller 38, such as instantaneous fuel consumption, to provide assistance to the gas propulsion system 12.

As best shown in FIG. 3, the electric propulsion system 20 also includes a cooling circuit 40 to help dissipate heat generated in both the electric motor controllers 30 and the electric traction motors 24, 26. The cooling circuit 40 includes a radiator and cooling fan 42, which is preferably mounted in a front of the electric vehicle 10. The cooling circuit 40 also includes a pump 44 preferably located at a bottom of the vehicle 10 which pumps cooling fluid from the radiator 42 to the rear of the vehicle 10 and into a first one of the pair of electric motor controllers 30. Upon exiting the first motor controller, the cooling fluid is routed to the other one of the pair of motor controllers 30, after which the cooling fluid is routed to the respective electric traction motor 24, 26. Upon exiting this electric traction motor 24, 26, the cooling fluid is routed to the other electric traction motor 24, 26 and then back to the front of the vehicle 10 and into the radiator 42 thereby forming a closed loop hydraulic circuit. As shown in FIG. 4, in an exemplary embodiment, power lines and cooling lines to each of the electric traction motors 24, 26 are routed through flexible conduits 46 that are attached to the battery pack, with each of the electric traction motor power lines routed in the battery pack 32 and connected to the motor controller 3 phase output terminals (i.e., inverters).

As discussed above, the electric propulsion system 20 is designed to assist the existing gas propulsion systems 12 by reacting to vehicle conditions, such as instantaneous fuel consumption, and adjusting the electric power supplied to either of the second wheels 22 accordingly. For example, an instantaneous vehicle CAN message can be received at the system controller 38 and sent to each of the electric motor controllers 30 and be input into a software algorithm stored thereon for controlling the respective electric traction motors 24, 26. In an exemplary embodiment, the software algorithm utilizes a modified PID control strategy which amplifies error between a set target and an inputted vehicle CAN message to provide an instantaneous power command which either increases or reduces power to the electric motors 24, 26.

In an exemplary embodiment, and as illustrated below, the software algorithm is programmed to utilize instantaneous fuel consumption to assist the combustion engine and/or compensate vehicle systems, such as torque “smoothing” on coast and deceleration, regeneration on braking, and power compensation based on motor and motor controller temperatures. However, other vehicle conditions which are available and capable of being monitored on the vehicle CAN bus, such as MAP (manifold absolute pressure), MAF (mass air flow), RPM (engine rpm), TP (throttle position), SA (spark advance), S (vehicle speed), MAT (air temperature), O2 (oxygen sensor/lambda sensor), EGT (exhaust gas temperature), IPW (injector pulse width), FRP (fuel rail pressure) and ACC (accelerometer(s)), can also be utilized by the electric motor controllers 30 to infer instantaneous fuel consumption, or other vehicle conditions, without departing from the scope of the subject disclosure.

For example, each electric motor controller 30 can utilize signals received from the system controller 38 to send controls to increase or decrease power to the electric motors based on the following software algorithm:

If (Gas Pedal>0 position) & (Vehicle Speed>1 Kph) & (DOD<95%), then Inew,i=Iprevious,i+(UL,i−Target)*Ratio, Else Inew,i=0, where:

Inew,i=New Controller Current Command: e.g., defined in the range of [−lmin to Imax] AMPS;

Iprevious,i=Previous Controller Current Command: e.g., defined in the range of [−lmin to Imax] AMPS;

UL,i=actual fuel consumption (e.g., decimal value of CAN that can be converted to microliters per 100 msec);

Target=target fuel consumption (e.g., decimal value of CAN representing microliters per 100 msec);

Ratio=control law proportional gain (e.g., converts the fuel consumption error to an equivalent current error);

DOD=battery depth of discharge (e.g., 100% indicates that the battery is fully discharged);

For example, each electronic motor controller 30 can additionally utilize signals received from the system controller 38 to send controls to increase or decrease power to the electric traction motors 24, 26 based on the following software algorithm:

If (Brake Pedal>0 position) & (DOD>5%), then Inew,I=−lmin (e.g., 100% regeneration executed), Else Inew,i=0.

For example, each electronic motor controller 30 can additionally utilize signals received from the system controller 38 to send controls to increase or decrease power to the electronic motors based on the following algorithm.

Define: Tm=max (Tm1, Tm2), where Tm1=measured internal winding temperature of electric traction motor 1, and Tm2=measured internal winding temperature of electric traction motor 2;

Where T=temperature compensation factor (defined in range: 0<T<1); Define: Imax,T=Imax*T; Define: Imax,T,V=Imax*f(V,T); Define: Imin,T=Imin*T;

Where V=vehicle speed; Imax,i=min(Imax, Imax,T, ImaxT,V); Imin,i=min(lmin, Imin,T).

As best shown in FIG. 2, in an exemplary embodiment, the communication between the engine module 18 and the system controller 38 of the electric propulsion system 20 is unidirectional (i.e. the electric propulsion system 20 is designed to only read existing vehicle conditions and does not communicate back to the engine module 18). Accordingly, the electric propulsion system 20 remains independent from existing vehicle systems., and can assist the vehicle combustion engine while remaining transparent to existing vehicle dynamic aids such as ABS, TC (traction control) and DVS (dynamic vehicle stability) systems.

The foregoing description of the embodiments has been provided for purposes of illustration and description. It is not intended to be exhaustive or to limit the disclosure or claims. Individual elements or features of a particular embodiment are generally not limited to that particular embodiment, but, where applicable, are interchangeable and can be used in a selected embodiment, even if not specifically shown or described. Many modifications and variations to the above embodiments, and alternate embodiments and aspects are possible in light of the above disclosure. Such variations are not to be regarded as a departure from the disclosure, and all such modifications are intended to be included within the scope of the disclosure. The modifications and variations to the above embodiments, alternate embodiments, and aspects may be practiced otherwise than as specifically described while falling within the scope of the following claims.

What is claimed is:

1. An electric propulsion system for a vehicle including a pair of first wheels, a pair of second wheels, and an engine module, the electric propulsion system comprising:
at least one electric traction motor operatively connected to either the first or the second wheels;
at least one electric motor controller in electrical communication with said at least one electric traction motor;
a system controller in electrical communication with the engine module to read vehicle signals therefrom; and
wherein said at least one electric motor controller is in electrical communication with said system controller and configured to control said respective electric traction motors based on signals received from said system controller.

2. An electric propulsion system as set forth in claim 1, wherein said electric motor controller is configured to controls said electric traction motors based on an instantaneous fuel consumption signal received from said system controller.

3. An electric propulsion system as set forth in claim 1, wherein said electric motor controller is configured to control said respective electric traction motors based on at least one of the following signals received from said system controller: MAP (manifold absolute pressure), MAF (mass air flow), RPM (engine rpm), TP (throttle position), SA (spark advance), S (vehicle speed), MAT (air temperature), O2 (oxygen sensor/lambda sensor), EGT (exhaust gas temperature), IPW (injector pulse width), FRP (fuel rail pressure) or ACC (accelerometer(s)).

4. An electric propulsion system as set forth in claim 1, wherein said electrical communication between the engine module and said system controller is a unidirectional electrical communication from the engine module to said system controller.

5. An electric propulsion system as set forth in claim 1, where said at least one electric motor controller is electrically connected to a battery pack.

6. An electric propulsion system as set forth in claim 1, further comprising a cooling circuit establishing a closed loop hydraulic circuit with each of said electric traction motors and said at least one electric motor controller.

7. An electric propulsion system as set forth in claim 6, wherein said cooling circuit includes a radiator, a cooling fan, and a pump.

8. An electric propulsion system as set forth in clam 1 wherein said at least one motor controller is mounted to respective wheels.

9. An electric propulsion system as set forth in claim 1, wherein said at least one electric traction motor includes a first electric traction motor operatively connected to one of the first wheels and a second electric traction motor operatively connected to the other one of the first wheels, and said at least one electric motor controller is in electrical communication with said first and second electric traction motors.

10. An electric propulsion system as set forth in claim 9, wherein a first one of said electric motor controllers is in electrical communication with said first electric traction motor and powered by a first battery pack, and a second one of said electric motor controls is in electrical communication with said second electric traction motor and powered by a second battery pack.

11. A modular hybrid system for a vehicle comprising:
a gas propulsion system driving a pair of first wheels;
a system controller in communication with said gas propulsion system;
an electric propulsion system driving a pair of second wheels; and
said system controller configured to read vehicle signals from said gas propulsion system and convey signals to said electric propulsion system to drive said pair of second wheels based on the vehicle signals from said gas propulsion system.

12. A modular hybrid system as set forth in claim 11, wherein said electric propulsion system includes:
at least one electric traction motor operatively connected to the pair of second wheels;
at least one electric motor controller in electrical communication with said at least one electric traction motor and said system controller; and
wherein said at least one electric motor controller of said electric propulsion system is configured to control said respective electric traction motors to drive the pair of second wheels based on the signals received from said system controller.

13. A modular hybrid system as set forth in claim 12, wherein said at least one electric motor controller commands said electric traction motors to increase or reduce power applied to said second pair of wheels.

14. A modular hybrid system as set forth in claim 11, wherein said electric propulsion system receives the signals from said system controller based on the vehicle signals from said gas propulsion system and does not output signals to said gas propulsion system.

15. A modular hybrid system as set forth in claim 11, wherein the vehicle includes an anti-lock brake system (ABS), traction control system (TC), and/or a dynamic vehicle stability system (DVS); and said electric propulsion system is independent from said anti-lock brake system (ABS), traction control system (TC), and dynamic vehicle stability system (DVS).
